(19) United States
(12) Patent Application Publication
(10) Pub. No.: US 2006/0285153 A1
(43) Pub. Date: Dec. 21, 2006

(54) Image forming apparatus having an integrated camera unit

(75) Inventor: Ju-Hyun Park, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd

(21) Appl. No.: 11/436,549

(22) Filed: May 19, 2006

(30) Foreign Application Priority Data
Jun. 21, 2005 (KR) 2005-0053616

(51) Int. Cl. G06F 3/12

(52) U.S. Cl. 358/1.15; 358/302

(57) ABSTRACT

An image forming apparatus with integrated camera is disclosed. A camera unit and a printing unit are integrated into the image forming apparatus, thus the image forming apparatus is capable of taking a picture of an object, printing an image of the object, and storing the image of the object. In one embodiment, a portable image forming apparatus with an integrated camera is provided that can print a photograph immediately after taking a picture of an object.

### PRIORITY

This application claims the benefit under 35 U.S.C. § 119(a) of Korean Patent Application No. 10-2005-0053616, filed on Jun. 21, 2005 in the Korean Intellectual Property Office, the entire disclosure of which is hereby incorporated by reference.

### BACKGROUND OF THE INVENTION

1. Field of the Invention

The present invention relates to an image forming apparatus. More particularly, the present invention relates to an image forming apparatus capable of printing an image in addition to performing various other functions.

2. Description of the Related Art

Generally, image forming apparatuses are printing or multi-functional devices that print letters or images onto a print medium. Due to recent improvements in print quality and greater use of digital cameras, many image forming apparatuses now also act as photograph printing stations for printing photographs.

In the conventional art, after taking a picture of an object with a digital camera, image data stored in the digital camera is printed by connecting the digital camera to a personal computer (PC) or an image forming apparatus via a universal serial bus (USB) cable. Alternatively, a memory card in which the image data is stored can be extracted from the digital camera and inserted into a card reader provided in the PC or the image forming apparatus to print the image data. However, the digital camera and the image forming apparatus cannot conveniently be connected without the USB cable or the card reader, thus image data cannot be immediately printed.

With power consumption of image forming apparatuses being reduced due to improvements in miniaturization and mobility of the image forming apparatus equipment, an image forming apparatus that can take a picture of an object as well as print an image of the object is needed to serve as a digital convergence product to create a new market.

### SUMMARY OF THE INVENTION

The present invention has been made to address the above mentioned need and provides an image forming apparatus that can take a picture of an object as well as print an image of the object.

According to an aspect of the present invention, there is provided an image forming apparatus capable of taking a picture of an object and printing an image of the object. The image forming apparatus comprises a camera unit comprising a lens portion and an image sensor portion which converts an optical image transmitted through the lens portion into an electrical signal. The image forming apparatus further comprises a printing unit comprising a signal processor portion which processes the electrical signal output from the image sensor portion into image data, and a printing portion which prints the image data onto a print medium.

The printing unit may further comprise a memory portion which stores the image data processed in the signal processor portion, and the image forming apparatus is capable of photographing, printing, and storing synthetically.

The memory portion may comprise a card reader/writer which can access an external memory card.

The printing unit may further comprise an image display portion which displays the image data processed in the signal processor portion as a visible image, and the image forming apparatus is capable of photographing, printing, and storing synthetically.

The image display portion may comprise a liquid crystal display panel pivotably coupled to an external case of the image forming apparatus and integrated with the camera unit.

The printing unit may further comprise an external device interface portion, which connects the signal processor portion and an external device so that image data can be received from the external device. The external device may be at least one of a personal computer, a digital camera, and a mobile phone with an integrated digital camera.

The printing portion may print the image data using a dye diffusion thermal transfer method.

The image forming apparatus may further comprise a battery unit that supplies power to the camera unit and the printing unit.

### BRIEF DESCRIPTION OF THE DRAWINGS

The above and other exemplary features and advantages of the present invention will become more apparent by describing in detail certain exemplary embodiments thereof with reference to the accompanying drawings, in which:

FIG. 1 is a block diagram illustrating the structure of an image forming apparatus according to an exemplary embodiment of the present invention;

FIG. 2 is a perspective view illustrating the exterior of the image forming apparatus illustrated in FIG. 1; and

FIG. 3 is a flow chart illustrating the order of operation of the image forming apparatus illustrated in FIG. 1 according to an exemplary embodiment of the present invention.

Throughout the drawings, like reference numbers should be understood to refer to like elements, features, and structures.

### DETAILED DESCRIPTION OF EXEMPLARY EMBODIMENTS

The matters exemplified in this description are provided to assist in a comprehensive understanding of various exemplary embodiments of the present invention disclosed with reference to the accompanying figures. Accordingly, those of ordinary skill in the art will recognize that various changes and modifications of the exemplary embodiments described herein can be made without departing from the scope and spirit of the claimed invention. Descriptions of well-known functions and constructions are omitted for clarity and conciseness.

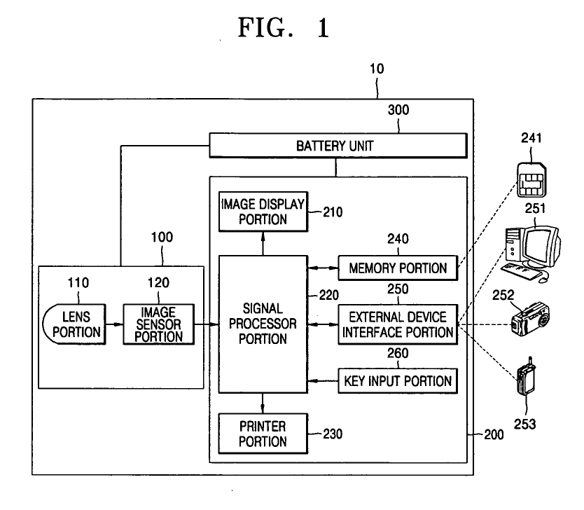

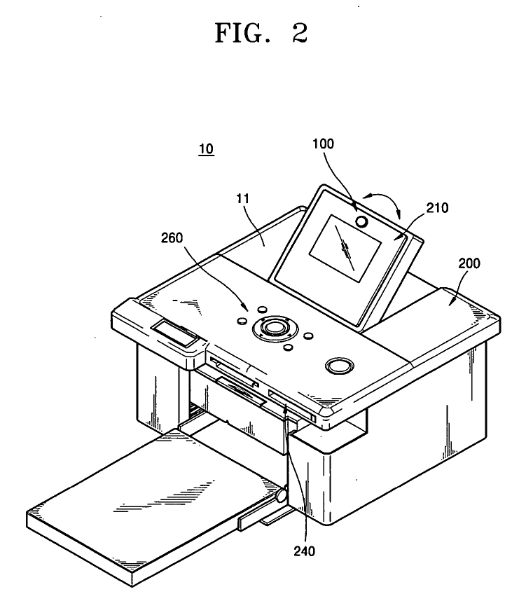

FIG. 1 is a block diagram illustrating the structure of an image forming apparatus 10 according to an exemplary embodiment of the present invention, and FIG. 2 is a perspective view illustrating the exterior of the image forming apparatus 10. Referring to FIGS. 1 and 2, the image forming apparatus 10 comprises a camera unit 100 integrated with a printing unit 200, which prints image data on a print medium, and a battery unit 300 which supplies power to the camera unit 100 and the printing unit 200.

The camera unit 100 comprises a lens portion 110 which captures an optical image of an object and an image sensor portion 120 which converts the optical image captured by the lens portion 100 into an electrical signal. As an example, the image sensor portion 120 may be a charge-coupled device (CCD) sensor or a complementary metal oxide semiconductor (CMOS) sensor. The image forming apparatus 10 of the present invention can take a picture of an object as well as print an image of the object.

The printing unit 200 includes a signal processor portion 220 and a printer portion 230, and may include an image display portion 210, a memory portion 240, an external device interface portion 250, and a key input portion 260.

The signal processor portion 220 is connected to the image sensor portion 120, and converts the electrical signal output from the image sensor portion 120 into image data. Also, the signal processor portion 220 performs a command input by a user who has pressed a key of the key input portion 260. As an example, the key input portion 260 comprises a menu key, a print key, a navigation key, a confirm key, and the key input portion 260 transmits various commands to the signal processor portion 220, such as a command for taking a picture of an object, performing zoom-in or zoom-out, printing image data, or selecting or editing image data stored in the memory portion 240.

The printer portion 230 is connected to the signal processor portion 220 and prints image data output from the signal processor portion 220 onto a print medium. The printer portion 230 can print the image data taken by the camera unit 100, as well as image data stored in memory portion 240, image data received from the external device interface portion 250, image data displayed on the image display portion 210, and so on. Although not illustrated, the printer portion 230 includes a print engine which prints the image data onto the print medium, a print medium storage section in which the print medium is stored, a print medium supply section which supplies the print medium stored in the print medium storage section to the print engine, and a print medium discharge section which discharges the print medium on which an image is printed to the outside of the image forming apparatus 10.

For example, the printer portion 230 may print image data in a dye diffusion thermal (D2T2) method. Although not illustrated, in the D2T2 method, when a thermal head's heat is applied to ink ribbons coated with dyes of four colors (for example, cyan, magenta, yellow, and black), the dyes are transferred onto a print medium, thereby printing image data on the print medium. The print medium can be a particular print paper in which the amount of ink that is diffused and transferred is controlled by the amount of heat applied from the thermal head. Although the resolution of the D2T2 type image forming apparatus is typically 300 dpi, several tens of million colors can be printed into a continuous tone, and thus gradation of delicate colors such as the colors of photographs can be expressed.

When printing an A6-sized photograph, the image forming apparatus 10 can be miniaturized and the print speed can be reduced to about one minute. Since power consumption can also be reduced, a portable image forming apparatus 10 can be provided. If the camera unit 100 and the battery unit 300 are integrated in the portable image forming apparatus 10, a portable image forming apparatus 10 can be configured in which a photograph can be immediately printed after taking a picture of an object, without connecting a power cable.

The memory portion 240 is connected to the signal processor portion 220 and stores image data. For example, the memory portion 240 comprises a card reader/writer (refer to FIG. 2) which can access an external memory card 241. The signal processor portion 220 reads image data from the external memory card 241 inserted in the card reader/writer and the printing portion 230 receives and prints the image data. The image forming apparatus 10 according to the present invention integrates photographing, printing, and storing of the image data.

The image display portion 210 displays the image data processed in the signal processor portion 220 as a visible image. For example, the image display portion 210 is pivotably coupled to an external case 11 of the image forming apparatus 10, and may include a liquid crystal display (LCD) panel (refer to FIG. 2) integrated with the camera unit 100. A user can edit the image data photographed by the camera unit 100 or the image data stored in the memory portion 240 while referring to the visible image displayed on the image display portion 210. The image forming apparatus 10 according to an exemplary embodiment of the present invention integrates photographing, printing, storing, and editing of image data.

The external device interface portion 250 is connected to the signal processor portion 220 so that image data output from an external device can be received. As an example, the external device may be one of a PC 251, a digital camera 252, and a mobile phone with an integrated digital camera 253. The external device can be connected via a wire such as a USB cable or can be wirelessly connected using Bluetooth, infrared data association (IrDA), and so on. The signal processor portion 220 receives image data from the PC 251, the digital camera 252, and the mobile phone with the integrated digital camera 253 connected to the external device interface portion 250 and transmits the image data to the printer portion 230 to print the image data.

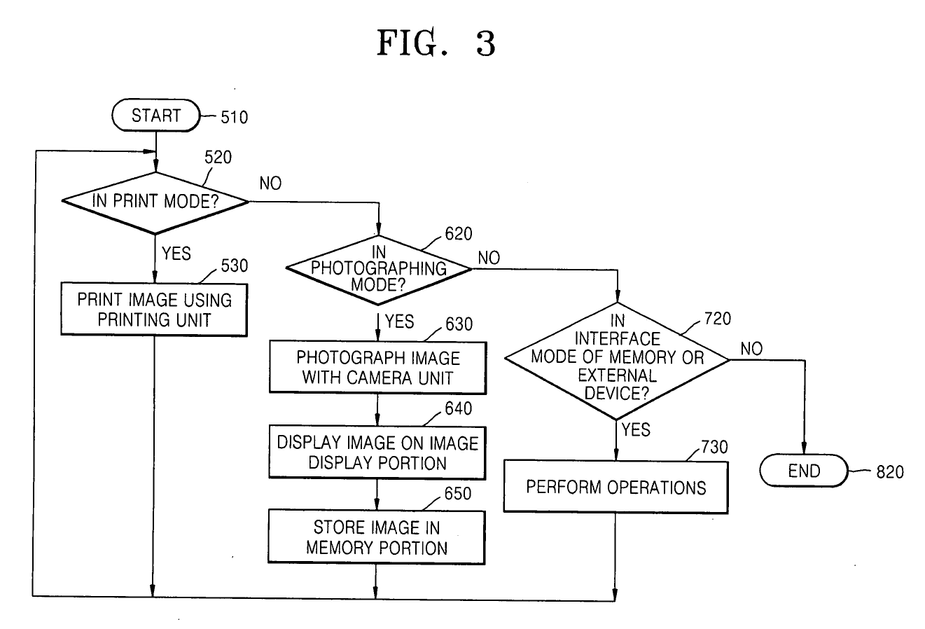

FIG. 3 is a flow chart illustrating the order of operation of the image forming apparatus 10 according to an exemplary embodiment of the present invention. FIG. 3 is an exemplary embodiment of the operation of the image forming apparatus 10, and the operation of the image forming apparatus 10 according to the present invention is not limited to the one illustrated in FIG. 3. Referring to FIG. 3, a print mode and a photographing mode are illustrated. First, the operation of the image forming apparatus 10 starts (510). The signal processor portion 220 determines whether the image forming apparatus 10 is operating in the print mode (520). If it is determined that the image forming apparatus 10 is operating in the print mode, the printing unit 200 prints image data (530). If it is determined that the image forming apparatus 10 is not operating in the print mode, the signal processor portion 220 determines whether the image forming apparatus 10 is in the photographing mode (620). If the image forming apparatus 10 is operating in the photographing mode, the camera unit 100 takes a picture of an object (630). The image display portion 210 displays the photographed image data in a visible image (640). The visible image displayed via the image display portion 210 can be edited by key input from the user or can be stored in the memory portion 240 (650). If it is determined that the image forming apparatus 10 is neither in the print mode nor the photographing mode, the signal processor portion 220 determines whether the image forming apparatus 10 is operating in an interface mode (720). If the image forming apparatus 10 is operating in the interface mode, image data is input and output to and from the camera unit 100, the printing portion 230, the image display portion 210, and an external device to perform operations such as at least one of photographing, printing, storing, and editing (730). If the image forming apparatus 10 is determined to be operating in neither the print mode, the photographing mode, or the interface mode, the operation of the image forming apparatus 10 ends (820).

As described above, an image forming apparatus integrates a camera unit and a printing unit according to an exemplary embodiment of the present invention, and the image forming apparatus is capable of taking a picture of an object, printing an image of the object, storing the image, and editing the image. In addition, a portable image forming apparatus can be configured which can immediately print a photograph after taking a picture of an object.

While the present invention has been particularly shown and described with reference to certain exemplary embodiments thereof, it will be understood by those of ordinary skill in the art that various changes in form and detail may be made therein without departing from the spirit and scope of the present invention as defined by the following claims and equivalents thereof.

What is claimed is:

1. An image forming apparatus comprising:
a camera unit comprising:
a lens portion; and
an image sensor portion which converts an optical image transmitted through the lens portion into an electrical signal; and
a printing unit comprising:
a signal processor portion which processes the electrical signal output from the image sensor portion into image data; and
a printing portion which prints the image data on a print medium
wherein the image forming apparatus is operable to take a picture of an object and print an image of the object.

2. The image forming apparatus of claim 1, wherein the printing unit further comprises a memory portion which stores the image data processed in the signal processor portion, and the image forming apparatus is capable of photographing, printing, and storing data.

3. The image forming apparatus of claim 2, wherein the memory portion comprises a card reader/writer which can access an external memory card.

4. The image forming apparatus of claim 2, wherein the printing unit further comprises an image display portion which displays the image data processed in the signal processor portion as a visible image, and the image forming apparatus is capable of photographing, printing, and storing data.

5. The image forming apparatus of claim 4, wherein the image display portion comprises a liquid crystal display panel pivotably coupled to an external case of the image forming apparatus and integrated with the camera unit.

6. The image forming apparatus of claim 1, wherein the printing unit further comprises an external device interface portion which connects the signal processor portion and an external device so that image data can be received from the external device.

7. The image forming apparatus of claim 6, wherein the external device is at least one of a personal computer, a digital camera, and a mobile phone with an integrated digital camera.

8. The image forming apparatus of claim 1, wherein the printing portion prints the image data using a dye diffusion thermal transfer method.

9. The image forming apparatus of claim 1, further comprising a battery unit which supplies power to the camera unit and the printing unit.

10. A method of operating an image forming apparatus comprising the steps of:
determining if the image forming apparatus is operating in one of a print mode and a photographing mode;
operating a camera via the image forming apparatus when in the photographing mode to generate and store image data of objects; and
printing selected image data when operating in the print mode.

11. The method as claimed in claim 10, further comprising the steps of:
determining if the image forming apparatus is operating in an interface mode; and
performing at least one of a plurality of operations comprising inputting selected image data to the camera and outputting selected image data from the camera.

12. The method as claimed in 11, wherein the image forming apparatus comprises a printer portion, and further comprising the step of providing selected image data to the printer portion.

13. The method as claimed in claim 11, wherein the image forming apparatus comprises an image display portion, and further comprising the step of providing selected image data to the image display portion.

14. The method as claimed in claim 11, wherein the image forming apparatus is connected to an external device operable to perform operations selected from the group consisting of photographing, printing, storing and editing image data, and further comprising the step of providing selected image data to the external device.

15. The method as claimed in claim 10, further comprising the steps of:
editing at least one of the image data photographed by the camera and the stored image data.
